(19) United States
(12) Patent Application Publication
(10) Pub. No.: US 2025/0356831 A1
(43) Pub. Date: Nov. 20, 2025

(54) SILENCING MEMBER

(71) Applicant: INOAC CORPORATION, Nagoya-shi, Aichi (JP)

(72) Inventors: Katsuhiro TANGE, Anjo-shi, Aichi (JP); Hiroki SUGIMOTO, Anjo-shi, Aichi (JP); Kazuya SASAZAWA, Anjo-shi, Aichi (JP); Kenji YASUDA, Anjo-shi, Aichi (JP)

(73) Assignee: INOAC CORPORATION, Nagoya-shi, Aichi (JP)

(21) Appl. No.: 18/873,406

(22) PCT Filed: Jun. 23, 2023
(86) PCT No.: PCT/JP2023/023260

§ 371 Date: Dec. 10, 2024

(30) Foreign Application Priority Data
Jun. 28, 2022 (JP) 2022-103884

(51) Int. Cl. G10K 11/175; G10K 11/162

(52) U.S. Cl. CPC G10K 11/175; G10K 11/162

(57) ABSTRACT

A silencing member includes: a first space; a second space that is disposed adjacent to the first space; a passage that connects the first and second spaces; a first member that surrounds the bottom surfaces and/or the side surfaces of the first and second spaces; and a membrane-shaped second member that covers the top surfaces of the first and second spaces.

### TECHNICAL FIELD

The present disclosure relates to a silencing member.

### BACKGROUND ART

Conventionally, there is known a silencing member that cancels out and attenuates input sound by outputting a cancellation wave of the opposite phase to the input sound wave (e.g., see Patent Document 1).

### CITATION LIST

### Patent Literature

[Patent Document 1] Japanese Patent Laid-Open No. 2012-47168

### SUMMARY OF INVENTION

### Technical Problem

The silencing member disclosed in Patent Document 1 has a structure including: a space that includes a pair of openings; a pair of wave-transmitting-and-receiving membranes that respectively cover the openings; and a seesaw member that couples the pair of wave-transmitting-and-receiving membranes. In the silencing member disclosed in Patent Document 1, the vibration of one wave-transmitting-and-receiving membrane occurring as a result of the one wave-transmitting-and-receiving membrane receiving noise is transmitted to the other wave-transmitting-and-receiving membrane by the seesaw member. This results in the other wave-transmitting-and-receiving membrane transmitting a cancellation wave of the same frequency and opposite phase to the vibration of the one wave-transmitting-and-receiving membrane. Thus, the silencing member can cancel off the noise sound wave using the cancellation wave.

Meanwhile, in the silencing member disclosed in Patent Document 1, a space for disposing the seesaw member, which connects the wave-transmitting-and-receiving membranes, needs to be provided. Due to this, an installation location where sufficient space can be secured needs to be selected upon installing the silencing member.

The present disclosure addresses the problem of providing a silencing member that can be installed in smaller spaces and locations.

### Solution to Problem

A silencing member according to one aspect of the present disclosure includes: a first space; a second space that is disposed adjacent to the first space; a passage that connects the first and second spaces; a first member that surrounds the bottom surfaces and/or the side surfaces of the first and second spaces; and a membrane-shaped second member that covers the top surfaces of the first and second spaces.

According to this silencing member, the adjacent first and second spaces are coupled via the passage. Thus, the silencing member can quickly transmit vibration input to one space to the other space via the passage. Due to this, the portion of the second member covering the other space can quickly generate a cancellation wave of the opposite phase to the input sound wave. Thus, the silencing member can attenuate input noise without the need of providing a component that connects portions of the second member. Consequently, the silencing member can be installed in smaller spaces and locations.

### Advantageous Effects of Invention

According to the present disclosure, a silencing member that can be installed in smaller spaces and locations can be provided.

### BRIEF DESCRIPTION OF DRAWINGS

FIG. 1 is a perspective view illustrating a silencing member in a first embodiment of the present disclosure.

FIG. 2 is a cross-sectional view illustrating the A-A cross-section in FIG. 1.

FIG. 3 is a top view illustrating the silencing member in the first embodiment of the present disclosure.

FIG. 4 is a schematic diagram illustrating the sound attenuation mechanism in the first embodiment of the present disclosure.

FIG. 5 is an exploded perspective view illustrating a silencing member in a second embodiment of the present disclosure.

FIG. 6 is a top view illustrating the silencing member in the second embodiment of the present disclosure.

FIG. 7 is a cross-sectional view illustrating the B-B cross-section in FIG. 6.

### DESCRIPTION OF EMBODIMENTS

### First Embodiment

In the following, a first embodiment of the present disclosure will be described with reference to the drawings. In the drawings, mutually orthogonal X, Y, and Z axes are illustrated in order to specify directions.

In the present embodiment, description will be provided taking as an example a silencing member that can be affixed to a headliner or the like in an automobile, etc.

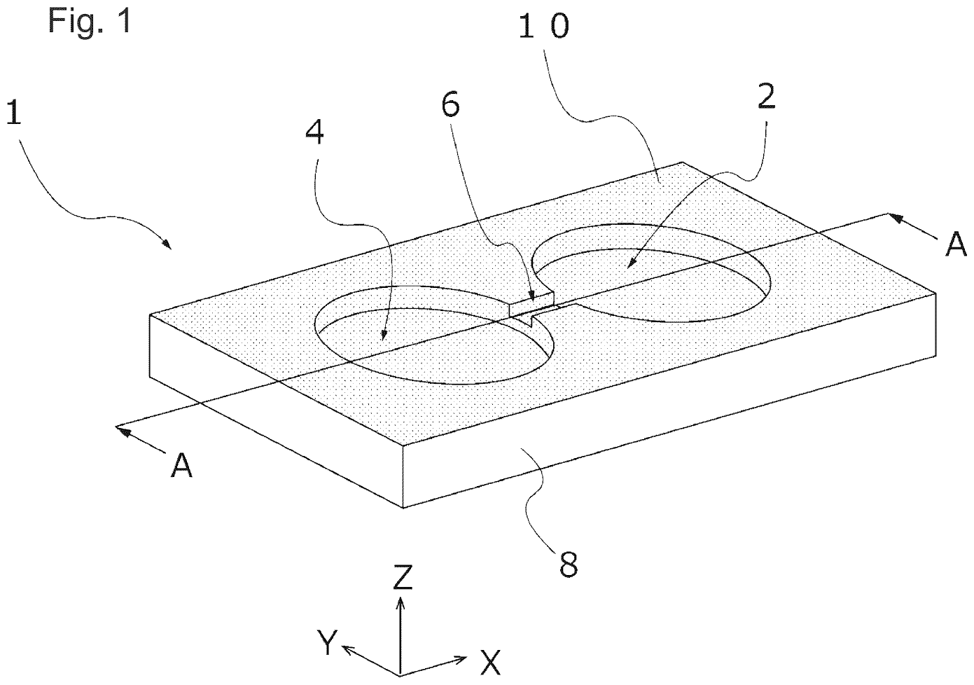

As illustrated in FIG. 1, a silencing member 1 includes: a first space 2; a second space 4 that is disposed adjacent to the first space 2; a passage 6 that connects the first space 2 and the second space 4; a first member 8 that surrounds the bottom surfaces and/or the side surfaces of the first space 2 and the second space 4; and a second member 10 that covers the top surfaces of the first space 2 and the second space 4.

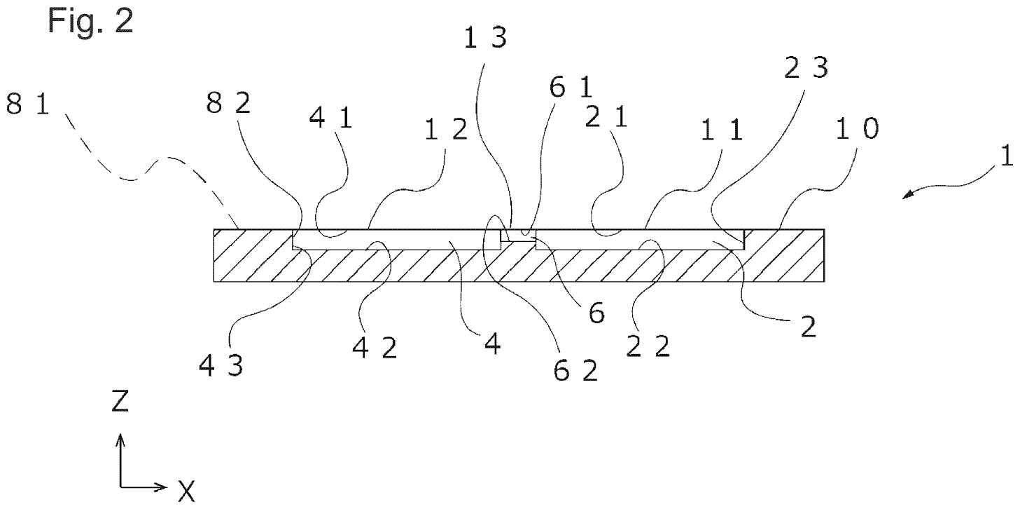

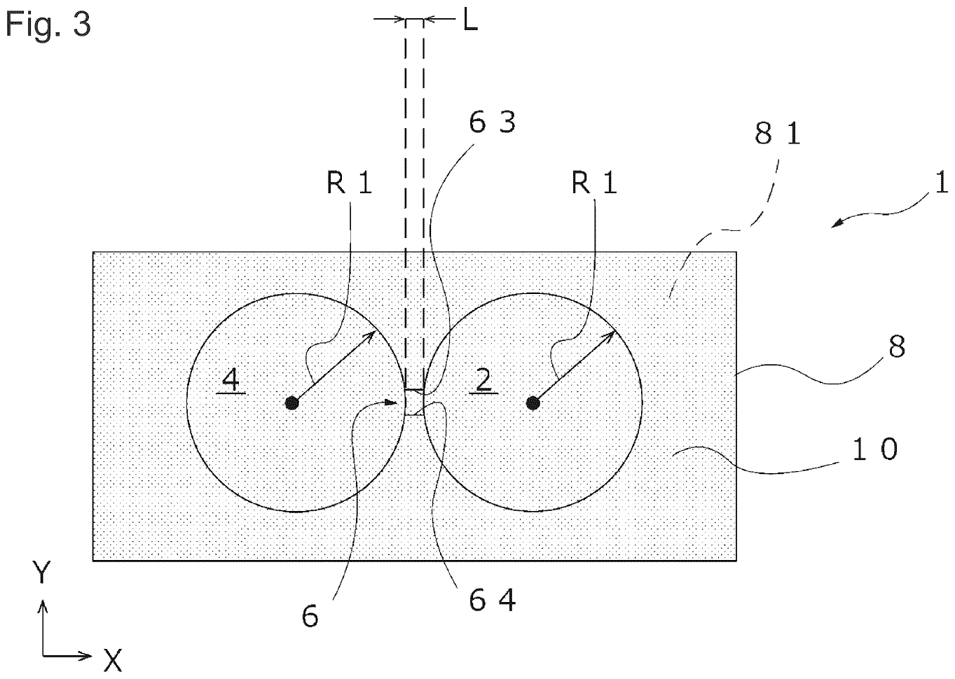

As illustrated in FIG. 2, the first space 2 is a hollow space that is surrounded by a top surface 21, a bottom surface 22 opposing the top surface 21, and a side surface 23. The top surface 21 and the bottom surface 22 in the present embodiment both have a circular shape having a radius R1 (see FIG. 3). That is, the first space 2 has the shape of a circular cylinder. However, there is no limitation to this; while the top surface 21 of the first space 2 preferably has a circular shape, the top surface 21 may have other shapes. For example, the first space 2 may be formed so as to have a semispherical shape or various other shapes.

The bottom surface 22 and the side surface 23 of the first space 2 in the present embodiment are defined by the first member 8. Furthermore, the top surface 21 of the first space 2 is defined by the second member 10.

The second space 4 is a hollow space that is surrounded by a top surface 41, a bottom surface 42, and a side surface 43. The top surface 41 and the bottom surface 42 in the present embodiment both have a circular shape having the radius R1 (see FIG. 3). That is, the second space 4 has the shape of a circular cylinder. However, there is no limitation to this; while the top surface 41 of the second space 4 preferably has a circular shape, the top surface 41 may have other shapes. For example, the second space 4 may be formed so as to have a semispherical shape or various other shapes.

As is the case with the first space 2, the bottom surface 42 and the side surface 43 of the second space 4 in the present embodiment are defined by the first member 8. Furthermore, as is the case with the first space 2, the top surface 41 of the second space 4 is defined by the second member 10.

The top surface 21 of the first space 2 and the top surface 41 of the second space 4 may be formed so as to be equal in area. More preferably, the top surface 21 of the first space 2 and the top surface 41 of the second space 4 are formed so as to have the same shape. As illustrated in FIG. 3, the top surface 21 of the first space 2 and the top surface 41 of the second space 4 in the present embodiment are both formed so as to have a circular shape having the radius R1. However, there is no limitation to this; the top surface 21 of the first space 2 and the top surface 41 of the second space 4 may be formed so as to have mutually different shapes.

The first space 2 and the second space 4 may be formed so as to be equal in volume. In the present embodiment, the top surface 21 and the bottom surface 22 of the first space 2, and the top surface 41 and the bottom surface 42 of the second space 4 all have a circular shape having the radius R1. Furthermore, the side surface 23 of the first space 2 and the side surface 43 of the second space 4 are formed so as to have equal size in the height direction (direction indicated by the arrow Z in FIG. 2). Thus, the first space 2 and the second space 4 in the present embodiment are formed so as to have the shape of circular cylinders having the radius R1 and equal volume. However, there is no limitation to this; the first space 2 and the second space 4 may be formed so as to have mutually different shapes.

The first space 2 and the second space 4 in the present embodiment are formed so that the radius R1 is within the range of approximately 25-100 mm. The radius R1 may be approximately 10-200 mm. Furthermore, the first space 2 and the second space 4 are formed so that the size thereof in the height direction (direction indicated by the arrow Z in FIG. 2) is within the range of approximately 10-30 mm. The height-direction size of the first space 2 and the second space 4 may be approximately 5-50 mm.

The first space 2 and the second space 4 are disposed adjacent to one another. The first space 2 and the second space 4 in the present embodiment are disposed side by side with a distance of approximately 10 mm therebetween along the longitudinal direction (direction indicated by the arrow X in FIG. 2).

The passage 6 is a hollow space that is disposed between the first space 2 and the second space 4 and that connects the first space 2 and the second space 4. The passage 6 is surrounded by a top surface 61, a bottom surface 62 opposing the top surface 61, a first side surface 63, and a second side surface 64 opposing the first side surface 63. The bottom surface 62, the first side surface 63, and the second side surface 64 of the passage 6 in the present embodiment are defined by the first member 8. Furthermore, the top surface 61 of the passage 6 is defined by the second member 10.

As illustrated in FIG. 3, the passage 6 connects the first space 2 and the second space 4 with the shortest distance L at a position where the distance between the first space 2 and the second space 4 is smallest.

As illustrated in FIG. 2, the passage 6 in the present embodiment generally has a cuboidal shape having a rectangular cross-section. The passage 6 has smaller size than the first space 2 and the second space 4 in the height direction (direction indicated by the arrow Z in FIG. 2). The bottom surface 62 of the passage 6 in the present embodiment is disposed higher than the bottom surface 22 of the first space 2 and the bottom surface 42 of the second space 4. Alternatively, the bottom surface 62 of the passage 6 may be formed on the same plane as the bottom surface 22 of the first space 2 and the bottom surface 42 of the second space 4.

It is sufficient that the size of the passage 6 in the width direction (direction indicated by the arrow Z in FIG. 3) be smaller than the radius R1 of the first space 2 and the second space 4, and the width-direction size is approximately 5-10 mm. Furthermore, the width of the passage 6 may be approximately 2-20 mm. However, there is no limitation to this; the shape of the passage 6 can be changed in various ways, as along as the passage 6 connects the first space 2 and the second space 4.

The material for forming the first member 8 is not particularly limited. However, in order to reduce weight, a porous material is preferably used as the material for forming the first member 8. While a porous material that is not air-permeable may be used, the porous material is preferably air-permeable. For example, the pressure in the first space 2 and the second space 4 can be adjusted so as to be close to that of the outside when the first member 8 is formed using a porous material having a certain degree of air permeability. However, there is no limitation to this; the porous material may be used to adjust a parameter such as humidity in the first space 2 and the second space 4 so as to be close to that of the outside. Note that the certain degree of air permeability refers to a degree of air permeability that would not impair the operation and effects of the present invention. The first member 8 in the present embodiment is formed using foamed polyurethane. However, there is no limitation to this; the first member 8 may be formed using various materials, such as a fibrous material or foamed polyolefins such as foamed polypropylene.

The first member 8 in the present embodiment is formed so as to have an approximately cuboid outer shape. The first member 8 includes a top surface 81 and a recess portion 82 provided in the top surface 81. As illustrated in FIG. 3, the top surface 81 in the present embodiment is a flat surface that spreads along the length direction (direction indicated by the arrow X in FIG. 3) and the depth direction (direction indicated by the arrow Y in FIG. 3). The recess portion 82 in the present embodiment surrounds parts of the first space 2, the second space 4, and the passage 6.

However, there is no limitation to this; it is sufficient that the first member 8 surround at least part of the bottom surface 22 (42) and/or the side surface 23 (43) of the first space 2 and the second space 4. This results in at least part of the first space 2 and the second space 4 being surrounded by the air-permeable first member 8. Thus, the silencing member 1 can keep the temperature, air pressure, and humidity in the first space 2, the second space 4, and the passage 6 consistent with that of the outside.

The second member 10 is formed using a membrane member that is not air-permeable. As illustrated with dotted shading in FIGS. 1 and 3, the second member 10 in the present embodiment is a thin membrane that is semi-transparent. The second member 10 in the present embodiment is formed using thermoplastic polyurethane (TPU). However, there is no limitation to this; the second member 10 may be formed using various materials such as a thermoplastic olefinic elastomer (TPO) or ethylene-propylene-diene methylene linkage (EPDM; ethylene propylene rubber).

As illustrated in FIG. 2, the second member 10 includes a first portion 11, a second portion 12, and a third portion 13. The first portion 11 covers the top surface 21 of the first space 2. The second portion 12 covers the top surface 41 of the second space 4. The third portion 13 covers the top surface 61 of the passage 6.

As illustrated in FIG. 3, the second member 10 in the present embodiment is formed so that the size thereof in the length direction (X direction in FIG. 3) and the depth direction (Y direction in FIG. 3) is approximately equal to that of the top surface 81 of the first member 8.

The second member 10 in the present embodiment is bonded to the first member 8 by an adhesive applied in advance to the top surface 81 of the first member 8. It is sufficient that the second member 10 be bonded at least to the rim of the recess portion 82 in the top surface 81 of the first member 8. This results in the second member 10 closing off the top surface 21 of the first space 2, the top surface 41 of the second space 4, and the top surface 61 of the passage 6.

In the present embodiment, the second member 10 is a vibration membrane that covers the first space 2 and the second space 4. The portions of the second member 10 that cover the top surface 21 of the first space 2 and the top surface 41 of the second space 4 vibrate freely in accordance with the flow of air inside the first space 2, the second space 4, and the passage 6. For example, the thickness of the second member 10 is approximately 0.02-0.5 mm.

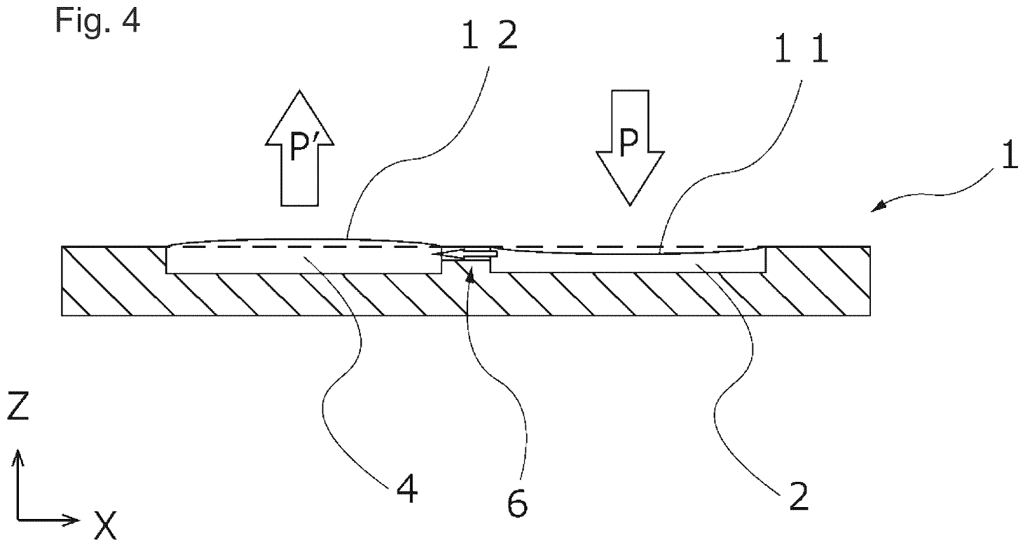

Next, the mechanism of sound attenuation by the silencing member 1 in the present embodiment will be described with reference to FIG. 4. FIG. 4 is a schematic diagram illustrating the sound attenuation mechanism when sound P is input to the silencing member 1. As illustrated in FIG. 4, sound P having a predetermined frequency is input to the first space 2 via the first portion 11 of the second member 10. Then, the first portion 11 of the second member 10 vibrates at a predetermined vibration frequency in accordance with the frequency and amplitude of sound P. FIG. 4 illustrates a state in which the first portion 11 of the second member 10 vibrating in response to the input of sound P is swelling toward the first space 2.

Next, sound P input to the first space 2 is transmitted from the first space 2 to the second space 4 via the passage 6. The first space 2 and the second space 4 are approximately equal in volume. Due to this, in response to the first portion 11 of the second member 10 vibrating at a predetermined frequency in accordance with sound P, the second portion 12 of the second member 10 vibrates at the same frequency as the first portion 11.

The second portion 12 vibrates in response to the vibration of the first portion 11. In the present embodiment, the top surface 21 of the first space 2 and the top surface 41 of the second space 4 are formed so as to be approximately equal in area. Thus, when the first portion 11 swelling toward the first space 2, the second portion 12 conversely swelling toward the outside of the second space 4. That is, the first portion 11 and the second portion 12 vibrate at the same frequency as one another but in opposite phases. This results in the second portion 12 outputting sound P′. Here, sound P′ output by the second portion 12 is of the opposite phase and same frequency as sound P input to the first portion 11. Consequently, the silencing member 1 can cancel out and attenuate sound P that is input.

On the other hand, when sound P is input to the second-space-4 side via the second portion 12 of the second member 10, vibration that is in accordance with sound P is transmitted from the second space 4 to the first space 2 via the passage 6. Thus, the first portion 11 of the second member 10 can output sound P′. In this case as well, sound P′ output by the first portion 11 is of the opposite phase and same frequency as sound P input to the second portion 12. Accordingly, when sound P is input to one of the first space 2 and the second space 4, the silencing member 1 can output, from the other one of the first space 2 and the second space 4, sound P′ of the opposite phase and same frequency as sound P that is input. Consequently, the silencing member 1 can attenuate sound P that is input.

Furthermore, by adjusting the area of the top surface 21 of the first space 2 and the top surface 41 of the second space 4, the volume of the first space 2 and the second space 4, and the thickness of the second member 10, the silencing member 1 can attenuate sound while targeting sound within a specific frequency band. The top surface 21 of the first space 2 and the top surface 41 of the second space 4 in the present embodiment are formed in a circular shape having the radius R1. Thus, by changing the radius R1 as appropriate, the sound-attenuating performance can be easily adjusted in accordance with the frequency band in which sound is to be attenuated.

### Second Embodiment

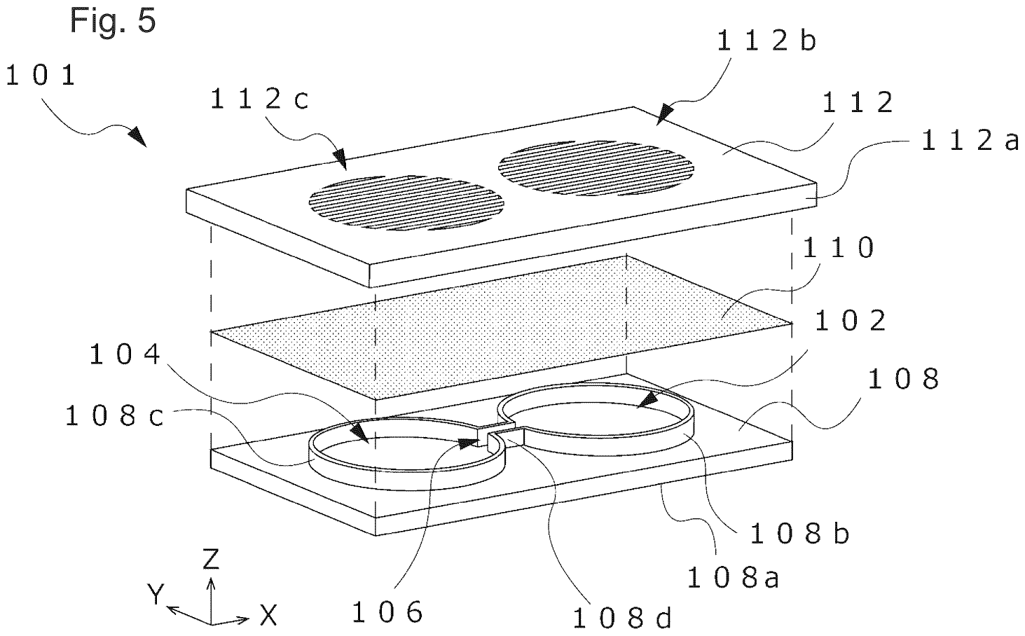

Next, a second embodiment of the present disclosure will be described with reference to FIGS. 5 to 7. As illustrated in FIG. 5, a silencing member 101 in the second embodiment includes: a first space 102; a second space 104; a passage 106; a first member 108; a second member 110; and a third member 112. Description of the first space 102, the second space 104, and the passage 106 in the present embodiment will be omitted because such description would be redundant in view of the first embodiment.

The first member 108 includes a base portion 108a, a first wall portion 108b, a second wall portion 108c, and a third wall portion 108d. The first member 108 in the present embodiment is formed using a thermoplastic resin material such as polypropylene, polyethylene, an acrylonitrile-butadiene-styrene copolymer (ABS resin), or a polycarbonate resin (PC resin).

The base portion 108a is a plate-shaped member that spreads along the length direction (direction indicated by the arrow X in FIG. 5) and the depth direction (direction indicated by the arrow Y in FIG. 5). The base portion 108a in the present embodiment is formed so that the size thereof in the height direction (direction indicated by the arrow Z in FIG. 5) is approximately 5-10 mm.

The first wall portion 108b is disposed on the base portion 108a and extends in the height direction. Together with the base portion 108a, the first wall portion 108b surrounds the first space 102. The first wall portion 108b in the present embodiment is formed so as to have the shape of a thin-walled hollow circular cylinder.

The second wall portion 108c is disposed on the base portion 108a and extends in the height direction, similarly to the first wall portion 108b. Together with the base portion 108a, the second wall portion 108c surrounds the second space 104. The second wall portion 108c in the present embodiment is formed so as to have the same shape as the first wall portion 108b.

The first wall portion 108b and the second wall portion 108c are disposed side by side on the base portion 108a.

The third wall portion 108d is a pair of vertical walls disposed between the first wall portion 108b and the second wall portion 108c. The third wall portion 108d surrounds the passage 106.

The second member 110 is a thin membrane disposed between the first member 108 and the third member 112. As is the case in the first embodiment, the second member 110 in the present embodiment is formed using a membrane member that is not air-permeable, and covers the first space 102, the second space 104, and the passage 106.

The second member 110 in the present embodiment is fixed by being sandwiched between the first member 108 and the third member 112.

The third member 112 covers the first member 108 and the second member 110. The third member 112 in the present embodiment is formed using a thermoplastic resin material having the same characteristics as the first member 108.

The third member 112 includes a fixing portion 112a, a first opening 112b, and a second opening 112c.

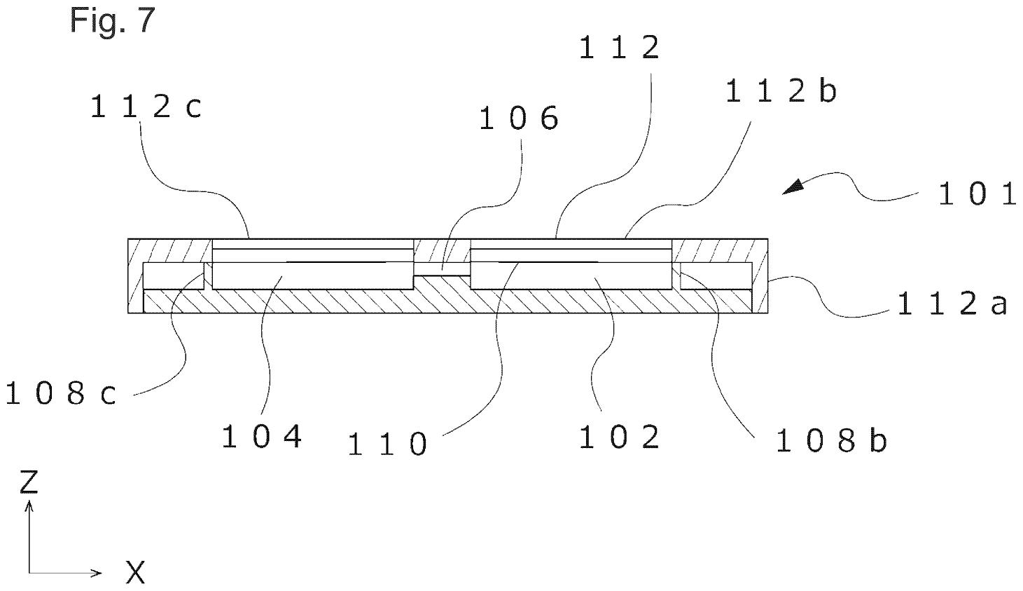

As illustrated in FIG. 7, the fixing portion 112a fixes the third member 112 to the first member 108. The fixing portion 112a in the present embodiment is a flange extending from the side surface of the third member 112. The fixing portion 112a is fastened to the side surface of the first member 108. This results in the third member 112 being fixed to the first member 108. Consequently, the second member 110 is fixed between the first member 108 and the third member 112, and covers the first space 102, the second space 104, and the passage 106.

However, there is no limitation to this; the fixing portion 112a may fix the third member 112 to the first member 108 in various ways. Furthermore, the second member 110 may be fixed to the first member 108 or the third member 112 in advance using an adhesive.

The first opening 112b is disposed above the first space 2 in a state in which the third member 112 is fixed to the first member 108. Similarly, the second opening 112c is disposed above the second space 4.

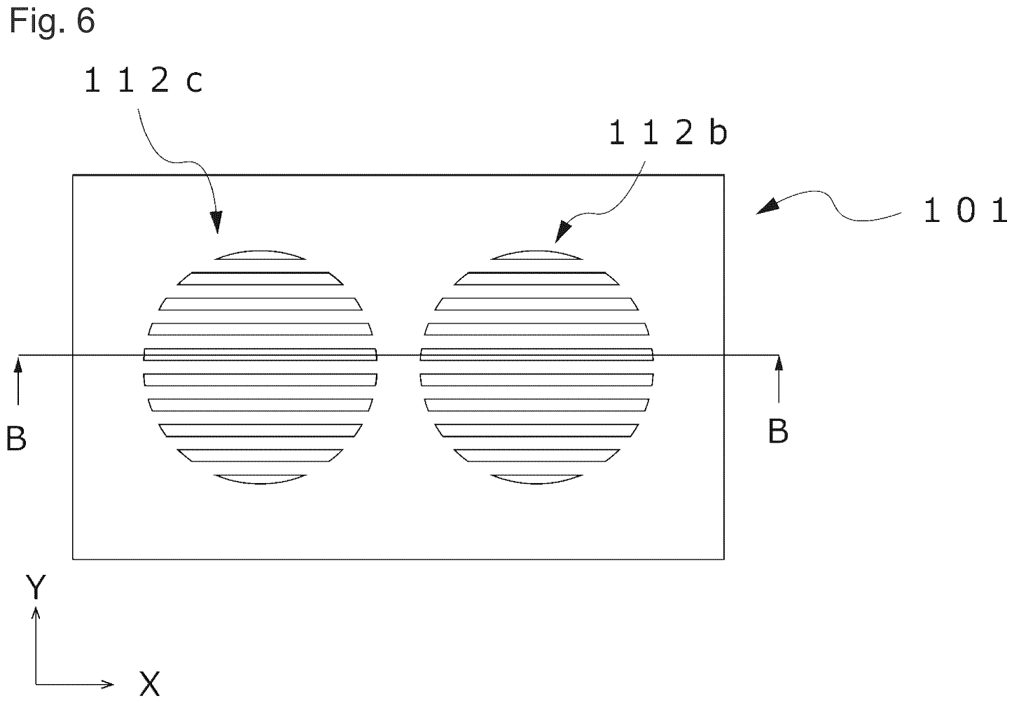

As illustrated in FIG. 6, the first opening 112b and the second opening 112c in the present embodiment are louvers. Thus, the first opening 112b and the second opening 112c can protect the first member 108 and the second member 110 without interrupting the transmission of sound that is input to and output from the silencing member 101. However, there is no limitation to this; the first opening 112b and the second opening 112c may be formed as a grid structure of a honeycomb shape or other geometric shape.

As described above, a simple-structured silencing member that can be installed in smaller locations and spaces can be provided according to the present disclosure.

### OTHER EMBODIMENTS

Embodiments of the present disclosure have been described above; however, the present disclosure is not limited to the above-described embodiments, and various modifications can be made thereto without departing from the spirit and scope of the invention.

For example, the first space (2, 102) and the second space (4, 104) in the silencing member (1, 101) in the above-described embodiments are formed so as to have the shape of a circular cylinder having the radius R1; however, the present disclosure is not limited to this. That is, the top surfaces of the first space (2, 102) and the second space (4, 104) are not limited to having circular shapes, and the top surfaces may also have mutually different shapes. In the silencing member (1, 101), it is sufficient that the first space (2, 102) and the second space (4, 104) be equal in volume, and the portions of the second member (10, 110) covering the first space (2, 102) and the second space (4, 104) have the same shape and thickness.

Furthermore, the first member (8, 108) in the silencing member (1, 101) in the above-described embodiments surrounds the bottom and side surfaces of the first space (2, 102) and the second space (4, 104); however, the present disclosure is not limited to this. That is, the first member (8, 108) may have a through-hole having the shape of the first space (2, 102), the second space (4, 104), and the passage (6, 106). In this case, one end portion of the through-hole may be covered by the second member (10, 110), and the other end portion of the through-hole may be covered by part of a headliner to which the silencing member (1, 101) is installed.

Furthermore, the silencing member (1, 101) in the above-described embodiments is installed to an automobile headliner; however, the present disclosure is not limited to this. That is, the silencing member (1, 101) may be installed to an automobile dashboard or various automobile body components. In such cases, it is sufficient that the silencing member (1, 101) be disposed so that the second member (10, 110) faces the sound source.

Furthermore, the silencing member (1, 101) in the above-described embodiments is installed to an automobile; however, the present disclosure is not limited to this. That is, the silencing member (1, 101) may be installed to walls of houses and buildings.

Furthermore, one each of the first space (2, 102), the second space (4, 104), and the passage (6, 106) is provided in the silencing member (1, 101) in the above-described embodiments; however, the present disclosure is not limited to this. That is, a plurality of first spaces (2, 102) and second spaces (4, 104) connected by passages (6, 106) may be disposed in the silencing member (1, 101). In this case, the first member (8, 108) may be formed in accordance with the size of the installation location, the curvature of the surface of the installation location, etc.

Furthermore, the first member (8, 108) in the above-described embodiments is formed using a porous material having a certain degree of air permeability; however, the present disclosure is not limited to this. That is, the material for forming the first member (8, 108) may be non-air-permeable. In this case, a control valve or the like may be provided to adjust parameters such as pressure and humidity in the first space (2, 102) and the second space (4, 104) so as to be close to that of the outside.

### REFERENCE SIGNS LIST

1, 101: Silencing member
2, 102: First space
4, 104: Second space
6, 106: Passage
8, 108: First member
10, 110: Second member
112: Third member

1. A silencing member comprising:
a first space;
a second space that is disposed adjacent to the first space;
a passage that connects the first and second spaces;
a first member that surrounds the bottom surfaces and/or the side surfaces of the first and second spaces; and
a membrane-shaped second member that covers the top surfaces of the first space, the second space, and the passage.

2. A silencing member comprising:
a first space;
a second space that is disposed adjacent to the first space;
a passage that connects the first and second spaces;
a first member that is formed from a porous material, and that surrounds the bottom surfaces and/or the side surfaces of the first and second spaces; and
a membrane-shaped second member that covers the top surfaces of the first and second spaces.

3. A silencing member comprising:
a first space;
a second space that is disposed adjacent to the first space;
a passage that connects the first and second spaces;
a first member that surrounds the bottom surfaces and/or the side surfaces of the first space, the second space, and the passage;
a membrane-shaped second member that covers the top surfaces of the first space, the second space, and the passage; and
a third member that covers the first and second members,
wherein the third member fixes the second member to the first member by sandwiching the second member between the first member and the third member.

4. The silencing member according to claim 1,
wherein the first and second spaces are formed so that the top surfaces thereof are equal in area.

5. The silencing member according to claim 1,
wherein the first and second spaces are formed so as to be equal in volume.

6. The silencing member according to claim 2,
wherein the porous material is air-permeable.

7. The silencing member according to claim 2,
wherein the first and second spaces are formed so that the top surfaces thereof are equal in area.

8. The silencing member according to claim 3,
wherein the first and second spaces are formed so that the top surfaces thereof are equal in area.

9. The silencing member according to claim 2,
wherein the first and second spaces are formed so as to be equal in volume.

10. The silencing member according to claim 3,
wherein the first and second spaces are formed so as to be equal in volume.
